(19) United States
(12) Patent Application Publication
(10) Pub. No.: US 2019/0297788 A1
(43) Pub. Date: Oct. 3, 2019

(54) Double cover greenhouse suitable for gardens and farming crops in lower ambient temperatures

(71) Applicant: Gerald R. Palmer, Phoenix, AZ (US)

(72) Inventor: Gerald R. Palmer, Phoenix, AZ (US)

(21) Appl. No.: 16/295,144

(22) Filed: Mar. 7, 2019

Related U.S. Application Data
(60) Provisional application No. 62/640,005, filed on Mar. 7, 2018.

(51) Int. Cl. A01G 9/14; A01G 13/02

(52) U.S. Cl. CPC A01G 9/1415; A01G 13/0206

(57) ABSTRACT

The disclosed invention is a greenhouse suitable for growing crops and edible pants which can be used for personal or commercial uses. The embodied invention includes supporting framework and for an inner and outer cover which allows for use in colder environments. A two cover-adjustable system allows the cover to expand as crops grow.

### CROSS REFERENCE TO RELATED APPLICATIONS

This application claims the benefit of U.S. provisional application No. 62/640,005 filed on Mar. 7, 2018. The entire disclosure of the provisional application is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

### (1) Field of the Invention

This invention is directed toward equipment and methods for gardens and farming where an enhanced environment is created for improved plant growth. It is also directed toward affordable greenhouses that provide an enhanced growing environment for plants.

### (2) Description of Related Art

Gardens are popular in the US with tomatoes being the most popular garden fruit grown, followed by cucumbers, sweet peppers, green beans, and carrots. Additionally, 35% of all households in America, or 42 million households, grow food at home or in a community garden (according to National Gardening Association articles published in 2014).

U.S. Pat. No. 9,357,718 discusses an insulated shell to overcome certain temperature conditions that hinder crop growth. However, the disclosure does not address water and crop growth issues related to an enclosed environment.

Similarly, US publication no. 20130152462 discloses the size and shape of a large greenhouse suitable for controlling the inner environment for plant growth. However, the disclosure is primarily concerned with the building construction details and does not disclose improvements that enhance crop growth.

U.S. Pat. No. 8,490,327 describes a greenhouse system that is moved between growing areas. However, the elaborate and relative expensive system of rails and rollers, and associated anchoring system, is relatively expensive.

Others have worked in a similar field of hydroponic farming systems. For example, US Publication no 20130255146 discloses a box that is used to control a plant climate. However, the types of materials needed to construct the protective shell around the plants requires expensive and elaborate systems that are unsuitable to mass production farming. Such stiff designs limit the size of a plant, limiting overall usefulness for a variety of plants.

The current art of greenhouses do not address the need for portability and scalability to create an affordable greenhouse suitable for a home, apartment, or cold weather environment. What is needed in the marketplace is a portable, small scale, production oriented plant growth environment and garden chamber which facilitates enhanced protection from environmental conditions including weeds, insects. Also, the environment and chamber must promote a suitable temperature, atmospheric content, and moisture level that allows improved crop growth and germination in a variety of climates, especially colder climates.

### BRIEF SUMMARY OF THE INVENTION

The disclosed invention is a greenhouse suitable for growing crops and edible pants which can be used for personal or commercial uses. The embodied invention includes supporting framework and for an inner and outer cover which allows for use in colder environments. A two cover-adjustable system allows the cover to expand as crops grow. Additionally,

1. Water is provided through a subterranean irrigation system or summer misting system.

2. CO₂ growth enhancement is provided by certain types of decomposing organics.

3. In winter, heat is generated by the decomposing of organic matter (such as manure not requiring electricity to provide heat).

4. Inset protection is provided by the inner cover and the outer cover is a shade cover The entire system usable in a broad variety of environmental and personal situations. It will work in dry desserts and cold climates.

### BRIEF DESCRIPTION OF THE SEVERAL VIEWS OF THE DRAWING(S)

FIG. 1 is a cross sectional view of the embodied invention showing important features.

FIG. 2 is a perspective view showing how the circular support frames are spaced and covered by an inner and outer cover.

FIG. 3 is a side view of the embodied invention showing how it is anchored with end stakes.

FIG. 4 is an end view of the greenhouse with the inner cover pulled back, and the outer cover not visible.

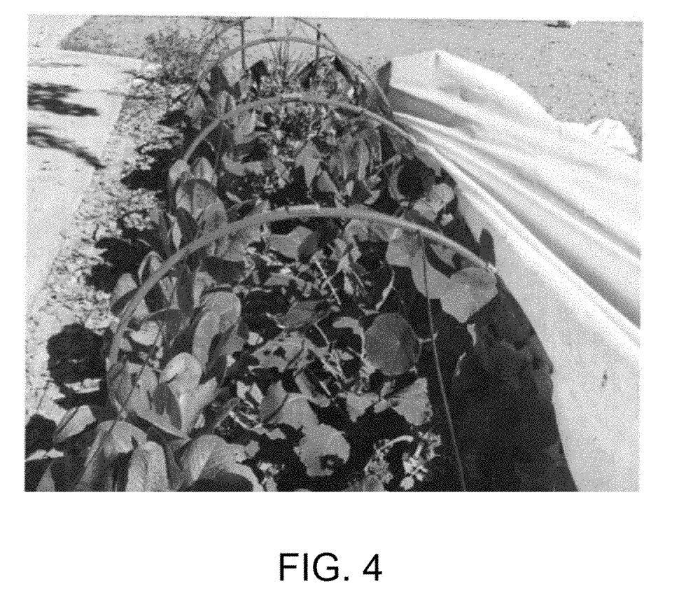

### DETAILED DESCRIPTION OF THE INVENTION

The disclosed invention is a simplified greenhouse which provides for a crop growing garden in challenging environments. The greenhouse includes features that provide for enhanced temperature, moisture control, and improved CO₂ levels, as well as protection from wind and insects. The enclosure provides for crop growth in temperature conditions as low as 0 degrees F.

The conceived invention has numerous benefits including:
1. Extend the gardening season throughout the year
2. Increase the efficiency and amount of food by the following.
   a) Harvest food continually by ‘shearing’ the outer leaves
   b) Harvest food by pruning plants
      plants and live up to 7 times longer than current harvesting methods
   c) Produce up to ten times the food achieved by current farming methods
   d) Use only as little as 20% of the water needed vs conventional methods
   e) Harvest only food as needed—reduces waste
   f) Use lightweight plastic tubing for irrigation, fertilization, and CO₂ atmospheric enhancement
   g) Provide a crop cover that:
      helps with weeds,
      helps avoid wind driven insects and controls wind damage
      allows 30% more food production
      provides a better controlled thermal and moisture environment
      provides frost cover, extending the growing season, and protection from snow and hail. Also provides a warm growth environment during the winter months.
3. Capture moisture lost through the leaves of the plants. (Transpiration. It is noted that an acre of corn can lose up to 4,000 gallons per day through transpiration in the leaves on a dry, windy day.)

Some important objectives include:
1. A faster growing plant and a longer crop growing season.
2. Higher humidity levels by using a covered system. A low humidity environment will cause many plant varieties to be stressed.
3. An enhanced ability to survive a drought cycle.
4. Providing for a small scale greenhouse, suitable and affordable for a family with limited space and financial means.

The greenhouse comprises an improved circular structural framework with dual top covers and a plastic ground cover. The plastic ground cover is installed under the plant growing soil provides additional temperature control as well as protection from insects. The soil takes up approximately half of volume defined by the circular structural framework. A water drip system is included which provides moisture control and fertilization.

The dual top covers allow sunlight to enter the garden chamber and provide for a space above the plant to initially grow. A gap is provided between the two top covers that provides for an improved thermal barrier in cold winters, and an additional cover providing shade and cooling in the summers.

Access to the plant and equipment in the simplified greenhouse is provided by allowing the two outer covers to be easily lifted/removed. The outer cover is held in place over a supporting framework by an elongated pipe, such as plastic or metal. The outer cover protects the inner cover and garden chamber from wind damage. The inner cover is held in place by an elongated weight that rests on trays connected to the framework.

A optional misting system above grade inside the inner cover provides additional cooling through evaporation during extreme heat. It would be turned on as needed in the summer days.

In an embodiment of the invention, an initial charge of manure is added to the soil inside the garden chamber to provide plant nutrients and a source of heat while it degrades. It is estimated that the garden chamber will have a temperature as much as 120-140° F. when the sun is shining. This can extend the growing season up to an additional 3 months in high latitude locations where temperatures are generally cooler.

Some plants can provide for enhanced production by how it is harvested. Iceberg lettuce, for example, can well tolerate shearing of the outside leaves without hurting plant growth. Such methods allow for higher production levels by not removing the entire plant when harvesting. Such a searing method can add up to an additional 4-5 times the normal production over a two-year plant growing/harvesting cycle.

The design and harvesting methods of the conceived invention can provide a significant amount of vegetables and fruit for a family of four for an entire year with a gardening chamber only twenty-four feet long.

The garden chamber provides 30% growth improvement when the atmosphere around the plant is enriched with CO₂. Normal atmospheric levels of approximately 400 ppm, can be increased in the garden chamber. A series of bags can be hung inside the garden chamber which uses mycelial (cultivated) to give off a relatively large amount of CO₂. Alternately, a pipe can be used to feed in a small percent of CO₂ to provide an enriched atmosphere to as much as 1,500 ppm. CO₂ enrichment only helps during the daylight hours when the sun is available for photosynthesis.

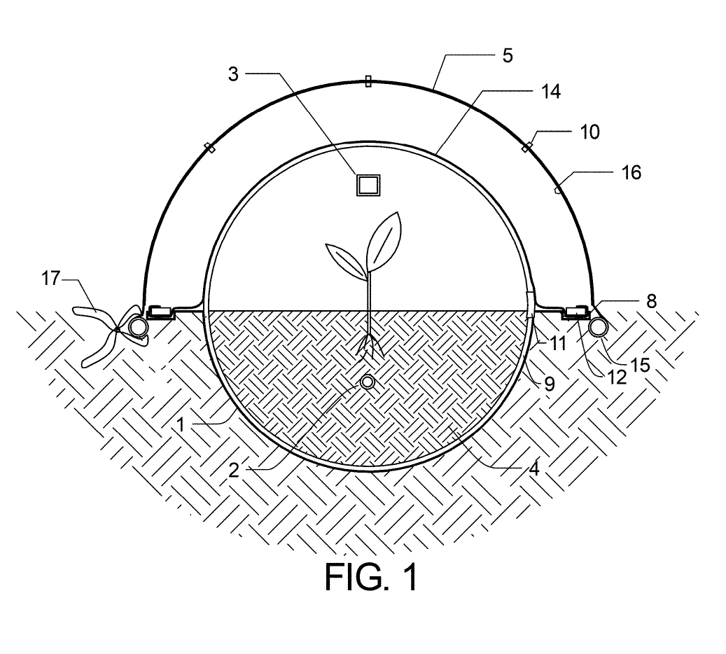

FIGS. 1-3 assembly parts comprise:
1. Black plastic film for ground moisture containment. A typical specification would be 3.5 mil HDX black plastic film 10×25 feet.
2. Drip pipe (irrigation pipe)
3. CO₂ atmosphere enriching bag (CO₂ bag by ExHale) or misting system
4. Ground soil
5. Outer cover—clear greenhouse plastic film 12×25 feet (especially suitable for high elevations)
6. Connecting strips
8. Rollup Holding Tray—screwed or attached to PEX pipe 9.
9. PEX (crosslinked polyethylene) pipe—¾-1″ diameter
10. Spacers (Velcro or clips) with attachment anchors to PEX Pipe 9.
11. PEX pipe connector
12. 1×3 inch flat wood cover roll up/weight.
14. Inner cover (made from fabric)
15. PVC pipes for cover holding
16. Rigid semicircle wire support for cover
17. Clamp

In FIG. 1, a black plastic film 1 is installed underneath a circular frame made of crosslinked polyethylene pipe (PEX) 9. The gardening soil 4 is enclosed by the black plastic film. A top inner cover 14 is installed over the top of the circular frame and tensioned against the frame by a roll-up board 12 which lays in a tray 8 that is attached to the circular frame. To facilitate installation of the circular frame, and to allow access, a connector 11 is used to enclose the circle of the circular frame. An irrigation pipe 2 below the gardening soil surface provides moisture and fertilizer to the plant row. An enhanced CO2 device 3 is attached to the circular frame (attachment not shown) and generates organically cultivated CO₂.

The polyethylene pipe 9 can be modified to let the inner (or outer) cover expand when the plant grows. For example, a telescoping section could be added to provide height expansion.

An outer cover 5 is attached to a semicircle wire support 16 and is tensioned against the wire support by two elongated PVC pipes 15 which are oriented parallel to the crop row. An optional clamp 17 provides additional gripping between the outer cover and the PVC pipes to ensure that the outer cover is wind resistant. Attachment clips 10, such as Velcro or a mechanical clip, additionally attach the outer cover 5 to the rigid wire 16.

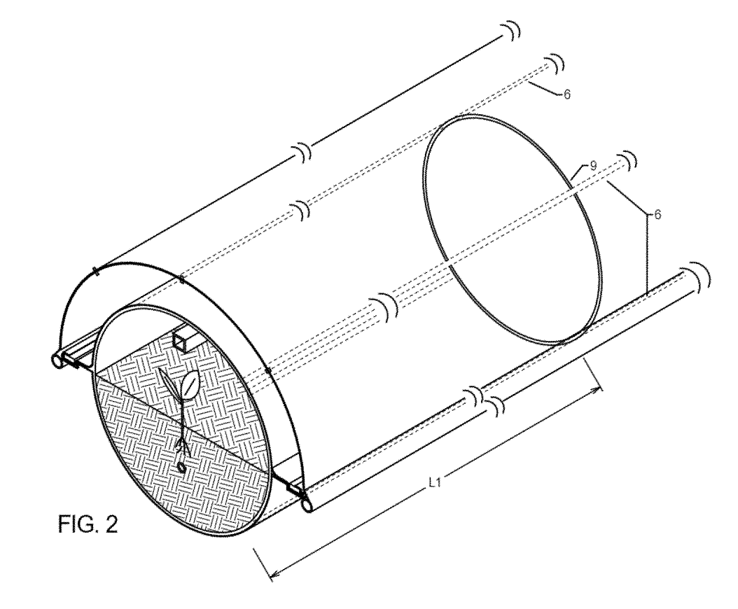

FIG. 2 shows a perspective view of FIG. 1 and highlights how the circular support frames 9 are spaced three feet apart with attaching straps 6 connecting the circular frames together to provide improved rigidity. In the currently conceived invention, five circular frames are spaced three feet apart L1 to provide an elongated garden row twelve feet long L2.

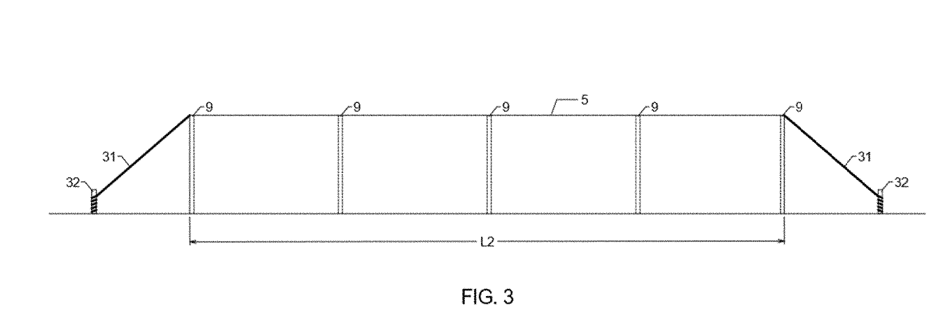

FIG. 3 shows a side view of the garden greenhouse where two end stakes 32 are attached to ropes 31 which anchor the outer cover and end circular frames 9, and by doing so, stiffens the entire garden greenhouse.

The dual cover—outer cover and inner cover—provides heat containment and shade. The outer cover is usually preferred for harsh environments (i.e. cold areas) is preferably porous. The outer and inner covers according to the conceived invention will protect the plants from hazards such as birds, insects, weed seeds, and wind damage.

The drip pipe (or drip tape) below the soil surface adds moisture based on a measurement of soil moisture content.

A no till gardening process allows a balanced microbial and fungus community that works symbiotically to promote plant health and growth.

In dessert areas creating a more humid growth environment during a dry hot season, can allow a more tropical variety of plants to grow in desserts.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A covered greenhouse assembly comprising:
A. a plurality of circular frames separated by a predetermined spacing distance,
1) wherein the center of said circular frames are aligned,
2) wherein the radial areas of said circular frames are parallel to each other,
3) a plurality of elongated strips connecting said circular frames,
4) wherein said elongated strips provide rigidity to the alignment positioning of said circular frames,
B. an inner cover attached to the upper portion of said circular frames,
C. a plurality of semicircular wire frames separated by said predetermined spacing distance,
D. an outer cover attached to said semicircular wire frames,
E. a pair of elongated outer cover anchors, wherein said elongated outer cover anchors are located on either side of said semicircular wire frames,
F. a pair of cover rollup boards used to tension said inner cover, wherein said rollup boards are positioned on either side of said semicircular wire frames,
G. a plurality of rollup board support trays, wherein said rollup board support trays are positioned under said rollup boards and attached to said circular frames,
H. a pair of hold down stakes,
1) wherein said hold down stakes are positioned inline with said circular frames,
2) wherein said hold down stakes connect the semicircular frame positioned at each end of the circular frame alignment to the ground,
I. a plastic ground cover attached to a lower half of said circular frames,
1) wherein said plastic ground cover is substantially below the soil ground level,
2) wherein said plastic ground cover encompasses growing soil,
J. an elongated irrigation pipe located in line with said circular frames and located below said growing soil, and
K. carbon dioxide addition element comprising:
1) a plurality of enhanced carbon dioxide creation devices attached to said circular frames, or
2) decomposing organic matter.

2. The covered greenhouse assembly according to claim 1, wherein said inner cover is expandable to increase interior height as the plants grow.

3. The covered greenhouse assembly according to claim 1, wherein said outer cover is expandable to increase interior height as the plants grow.
